(19) United States
(12) Patent Application Publication
(10) Pub. No.: US 2007/0154240 A1
(43) Pub. Date: Jul. 5, 2007

(54) Conductive roller for an image forming apparatus

(76) Inventors: Donald Leo Elbert, Lexington, KY (US); Jarrett Clark Gayne, Lexington, KY (US); David William Hullman, Lexington, KY (US); Johnny Dale Massie II, Lexington, KY (US); Michelle Kathryn Morris, Lexington, KY (US); Sean Smith, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/322,109

(22) Filed: Dec. 29, 2005

(51) Int. Cl. G03G 15/02; B05C 1/08

(52) U.S. Cl. 399/176; 492/18

(57) ABSTRACT

The present invention relates to conductive adhesives that may be used within an image forming apparatus. The image forming apparatus may include printing devices such as inkjet printers, electrophotographic printers, copiers, faxes, all-in-on devices or multi-functional devices. The conductive resins may be applied to the shaft of foam rolls suitable for transporting and applying image forming material in an image forming apparatus such as a laser printer.

### FIELD OF INVENTION

The present invention relates to the use of conductive adhesives within an image forming apparatus. The image forming apparatus may include printing devices such as inkjet printers, electrophotographic printers, copiers, faxes, all-in-on devices or multi-functional devices. The conductive resins may be applied to the shaft of foam rolls suitable for transporting and applying image forming material in an image forming apparatus such as a laser printer.

### BACKGROUND

An image forming apparatus may include a number of charged components. These components may take the shape of rolls such as charge rollers, toner supply rolls, developer rolls, cleaning rolls, photoconductive devices, etc. The charges applied to these rolls may be used to facilitate transporting the image forming substance from a reservoir to the media upon which the substance may be fixed. For example, the surface of a photoconductor may be charged to one potential and portions of the surface may then be selectively charged to another potential to form images on the photoconductive device. For example, a toner supply roll may be charged to one potential to attract an image forming substance from a reservoir and deposit the image forming substance to another roll that may be charged at a different potential, such as a developer roll. The developer roll may then be rotated so that it is brought into contact with a photoconductive drum and the toner on the developing roll may then be transferred onto the surface of the drum during a printing operation.

### SUMMARY OF THE INVENTION

In one exemplary embodiment, the present invention is directed at a conductive toner supply roller for use in supplying image forming material in an image forming apparatus. The suppler roller may include a conductive substrate, a conductive adhesive and a conductive foam layer including an outer foam surface, wherein the roller has substantially uniform Shore 00 Hardness across the foam surface.

In another exemplary embodiment, the present invention is directed at an electrically conductive component for use in an image forming apparatus comprising a conductive polymer foam having an outer surface wherein the foam exhibits a density of ≦10.0 pounds per cubic foot, a compression force deflection of ≦6.0 psi and a conductive layer having a thickness of ≦400 microns. The foam outer surface may have a Shore 00 Hardness between about 20-80 and the Shore 00 Hardness may be substantially uniform across such surface.

In yet another exemplary embodiment the present invention is directed at a method for applying toner to a developing member in an electrophotgraphic image-forming apparatus comprising applying toner via a roll comprising a conductive foam. The conductive foam has an outer surface wherein the foam exhibits a density of ≦10.0 pounds per cubic foot, a compression force deflection of ≦6.0 psi and a conductive layer having a thickness of ≦400 microns. The foam outer surface may have a Shore 00 Hardness between about 20-80 and the Shore 00 Hardness may be substantially uniform across such surface.

### BRIEF DESCRIPTION OF DRAWINGS

The detailed description below may be better understood with reference to the accompanying figures which are provided for illustrative purposes and are not to be considered as limiting any aspect of the invention.

FIG. 1 is a cross-sectional view of an exemplary embodiment of the present invention illustrating a roller for use in an image forming apparatus.

FIG. 2 is a cross-sectional of an exemplary embodiment of the present invention illustrating a toner supply roll, toner and a developer roll.

### DETAILED DESCRIPTION

The present invention relates to conductive adhesives which may be used within an image forming apparatus. The conductive adhesive may therefore be applied to a roller, blade or other component within the image forming apparatus or printer cartridge where it may be desirable to develop a conductive pathway and where it may also be useful to maintain such conductive pathway over the life of the cartridge assembly.

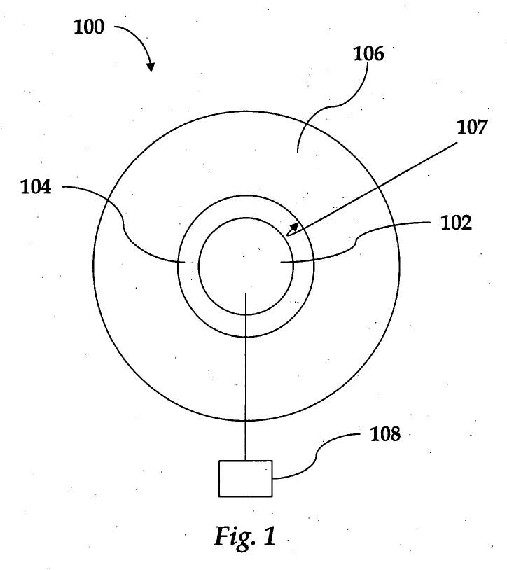

As illustrated in FIG. 1, the exemplary component 100 may be a roller and may include a conductive substrate such as shaft portion 102 (typically metallic), a conductive layer 104 and an outer layer 106. The roller may be a toner supply roller. The component may also be in some other form other than in the shape of a roller. The shaft portion 102 may include a conductive material such as metal and may have a voltage applied thereto by a power source or may be grounded to an electrical ground 108.

The outer layer 106 may be a polymeric resin which may be in the form of a foam type structure. Foam may include for example polyurethane, polyester, polypropylene, neoprene or silicone and may be open cell foam, including non-reticulated foam, or closed cell foam. One exemplary embodiment of the present invention includes polymeric foam which may have certain physical properties with respect to characteristics of foam density and/or compression force deflection as determined by ASTM D 3574-01. For example the foam may indicate densities of less than or equal to about 10 pounds per cubic foot (pcf), including all values and increments therebetween. This includes foam with densities less than or equal to about 9.0 pcf, or foams with densities of about 0.5-10.0 pcf. The invention herein may therefore also apply to foams with densities between about 5.0-9.0 pcf, or even foams with densities between about 6.0-9.0 pcf, or foams with densities between about 7.0-8.0 pcf.

The compression force deflection characteristic of foam material noted above is more specifically the variable of 25% compression force deflection (CFD) as also measured pursuant to ASTM D 3574-01. Accordingly, foams herein may include foams having a compression force deflection of less than or equal to about 6.0 pounds per square inch (psi), including all values and increments therebetween. Accordingly, the foams herein may have a CFD of less than or equal to about 2.0 psi. Furthermore, the CFD herein may vary about +/−0.5 psi, including all values and ranges less than or equal to about 0.5 psi. It can therefore be appreciated that the physical characteristics of foam density and/or compression load deflection characteristics may be controlled, and by way of example, a toner supply roller herein may include a foam density of about 6.0-9.0 pcf and a compression load deflection of with the range of about 0.8-1.2 psi.

In addition, another variable that may be utilized to characterize the foams herein is the variable of Shore 00 Hardness. The Shore 00. Hardness is reference to Shore Durometer testing which may be applied to relative soft materials, such as the foam materials herein. The Shore 00 Hardness scale ranges from 0-100, where 0 generally corresponds to full penetration and 100 generally corresponds to no penetration. Reference is therefore made to ASTM D 2240-00 for Shore Durometer testing. In the foam materials of the present invention, it has been found that the Shore 00 Hardness across the entire surface of the foam may fall in the range of about 20-80 including all values and any incremental range therebetween. For example, the Shore 00 Hardness may be about 40-60. In addition, it has been found that by uniformly coating, e.g., the shaft 102 of an exemplary toner supply roller with conductive adhesive, as between those contacting surface of the foam with the shaft, the toner supply roller may be produced where the Shore 00 Hardness varies less than or equal to about +/−5.0 units on the Shore 00 Hardness scale, including all increments and values therebetween. More precisely, the variation may be controlled to, e.g., less than or equal to about +/−2.5 units on the Shore 00 Hardness scale.

The exemplary rollers herein may have a shaft length of between 150-300 mm. In addition, the rollers may have a shaft outer diameter of between about 4-8 mm, and the roller with foam may have an outer diameter of between about 10-16 mm. Accordingly, foam thickness from the surface of the shaft may be about 3.0-4.0 mm. In addition, foam may be applied to a length of about 200-250 mm over the supporting shaft. However, these are only exemplary dimensions with respect to the present invention.

In the course of preparing the foam materials of the present invention, the foam may be one that is electrically conductive. Such conductivity may be developed via incorporation of electrically conductive additives. Such additives may be incorporated during the foam manufacturing process. The foam may also be made conductive by use of an electrically conductive coating.

The conductive additive may therefore amount to any compound that may convert the foam to an electrically conductive foam that may then be suitable for use in a printer, e.g., an electrophotographic printer. Non-limiting examples of conductive additives therefore include carbon black, other carbon based materials, including graphite, carbon nanotubes, carbon nanofibers, conductive polymeric material, ionic additives, metal particles, combination of such additives, etc. Other conductive additives that may be considered for use within the foam include ammonium salts such as perchlorates, chlorates, hydrochlorides, bromates, iodates, borofluroides, sulfates, ethyl sulfates, carboxylates, sulfonates, etc. of any tetraethyl ammonium, tetrabutyl ammonium, dodecyltrimethyl ammonium such as lauryltrimethyl ammonium, hexadecyltrimethyl ammonium, actodecyltrimethyl ammonium such as stearyltrimethyl ammonium, benzyltrimethyl ammonium, modified aliphatic dimethylethyl ammonium, etc.; perchlorates, chlorates, hydrochlorides, bromates, iodates, borofluorodides, tribluoromethyl sulfates, sulfonates, etc. of any alkali metals such as lithium, sodium and potassium, or alkaline earth metals such as calcium and magnesium, electroconductive metal oxides such as tin oxide, titanium oxide and zinc oxide, and metals such as nickel, copper, silver and germanium. In addition. to the above, one may also consider the use of hexahalogentated ionic compounds selected from the group consisting of potassium hexafluorophosphate, sodium hexafluorophosphate, and ammonium hexafluorophosphate may be used. The conductive additives may be used alone or in combination. The conductive additive may also be included in an amount effective to confer an electrical resistivity in the foam of less than or equal to about 1×10⁹ ohm-cm.

The outer layer 106 may next be attached to the shaft portion 102 using a resin layer 104 which may be an electrically conductive adhesive layer. The conductive adhesive layer may therefore serve to supply adhesive properties (to attach a foam layer to the shaft) and to introduce electrical conductive properties. The conductive adhesive layer may therefore include any material that will attach, e.g., a foam layer to a metal shaft and which is itself electroconductive. The conductive layer 104 may also include a layer of tape or film that is conductive and which includes adhesive.

Similar then to the above considerations with respect to developing electrically conductive type foam, the conductive adhesive herein may therefore include ion-polymer type systems (e.g. a salt dispersed in a solid polymer resin). However, it can be appreciated that the ionic additives may again broadly contemplate any organic or inorganic additive which provides an ionic charge to facilitate conductivity within a host resin system. Moreover, the conductive adhesive may contemplate polymers that conduct electricity by electronic transport (e.g., polymers that may include conjugation in conjunction with a dopant compound).

The conductive adhesive herein may have an electrical resistivity lower than the resistivity of the outer foam layer 106. This may therefore ensure a conductive path between the shaft and the outer layer. For example, the conductive adhesive herein may have a resistance of less than or equal to about 1×10⁷ ohm-cm and any range of values less than or equal to about 1×10⁷ ohm-cm, e.g. 1×10⁶ ohm-cm or about 1×10⁴ ohms-cm to about 1×10⁶ ohms-cm, etc. Furthermore, the conductive path established between the shaft and outer layer by use of the conductive adhesive/foam combination herein may serve to reduce an undesirable increase in resistance, or the approach to some maximum allowable resistance for a toner supply roller, over the life of a given printer cartridge.

The conductive adhesive may be applied to either or both the shaft 102 or to an inner surface 107 of the outer layer 106 using a number of techniques, such as spray coating, gravure coating, knife-over-roll coating, meyer and reverse rod coating, dip coating, flow coating, curtain coating, slot die coating, spin casting, and other coating or casting techniques. The adhesive may be applied to the entire surface of the shaft 102 or inner surface 107 of the layer 106 or it may be selectively applied at various locations (i.e. to a portion of the shaft surface). For example, the adhesive may cover between 1%-100% of the contacting surface between the shaft 102 and layer 106 and any increment or range therebetween, including 50%, 75% etc. The adhesive thickness may be controlled between about 10 to 400 microns (μm) including any value or range therebetween.

More precisely, the conductive adhesive may be applied to the entire contacting surface as between the shaft and foam, and the thickness may be controlled to, e.g., a thickness level of between about 25-250 μm. It may therefore be appreciated that such thickness level of conductive adhesive may also be combined with any of the conductive foam material characteristics noted above, e.g., foam material that provides a density of about 6.0-9.0 pcf along with a compression load deflection of about 0.8-1.2 psi, and wherein the Shore 00 Hardness may be within the range of 20-80 and also substantially uniform across the surface of the foam.

Furthermore, as noted to above, by applying conductive adhesive to the entirety of the aforementioned contacting surfaces, and/or via control of adhesive thickness, it may be the case that one may best avoid the development of differing Shore 00 Hardness responses across the surface of the foam which engages the developer roller. This may then reduce excessive wear at the roller surface and may also reduce the probability that the foam might delaminate from the roller over the course of cartridge life.

In addition, the conductive adhesive may be applied to the surface of shaft 102 and may also be the result of a polymerization on the surface, e.g. a single-component adhesive system which involves a crosslinking or polymerization type reaction upon exposure, e.g., to moisture. In such regard, this may include certain polyurethane based systems, silicone based systems and/or cyanoacrylate type materials. Moreover, another suitable composition that may be used as an adhesive herein may include a thermoplastic resin such as a hot melt adhesive. The hot melt adhesive may have an initial viscosity which exhibits a decrease at temperatures above a particular thermal transition temperature, such as the glass transition temperature (Tg) of the material or the melting temperature (Tm). For example, such temperatures may be about 150 degrees Fahrenheit and greater, such as 180 degree Fahrenheit, 210 degrees Fahrenheit, etc. The hot melt adhesive may be applied at the elevated temperature and may harden or increase in viscosity when the adhesive cools below a particular temperature. Exemplary hot melt adhesives may include acrylics, ethylene vinyl acetate copolymers, poly(vinyl acetate), polyethylene, nylons, amorphous polypropylene, styrene-isoprene-styrene copolymers, styrene-butadiene-styrene copolymers, or ethylene ethyl acrylate copolymers.

In another composition, the adhesive may be composed of at least two prepolymer materials that react with each other to provide an increase in molecular weight. The conductive agent may therefore be dispersed in one or more of the prepolymer materials. The prepolymer materials may include one or more resins, an activating agent such as a hardener, crosslinker or catalyst, and optionally additional additives. Exemplary multi-component adhesives may include epoxy, modified acrylic, polyurethane, silicone, etc. Accordingly, in one non-limiting exemplary embodiment, the adhesive may include a thermoset resin (e.g. a resin which contains crosslinks or is capable of crosslinking) such as an epoxy resin along with a conductive additive such as carbon black and graphite. The conductive adhesive herein may also include a resin that, while having some level of crosslinking, remains as one that is still capable of performing as a thermoplastic in the context of this invention.

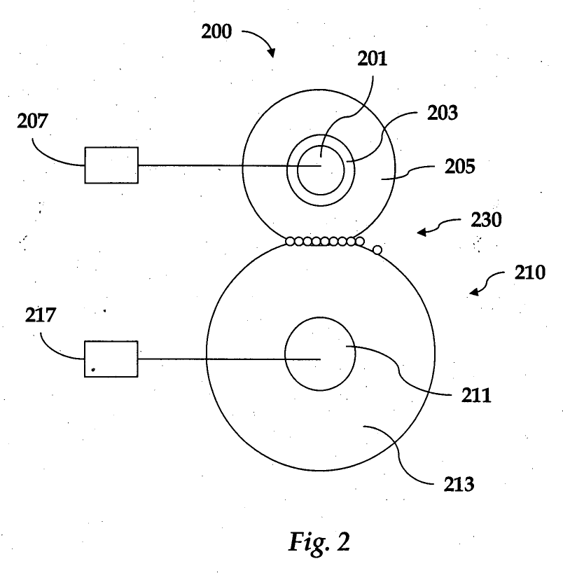

FIG. 2 illustrates one non-limiting exemplary embodiment of the present invention. Two components 200 and 210 may be positioned within a fixed contacting distance. The two components may include a toner supply roller 200 and a developer roller 210. The supply roller 200 may include a shaft 201, a conductive adhesive 203 and a layer 205. The second component 210 may be a developer roller and include a shaft 211 and a layer 213. Alternatively the second component may also include a conductive adhesive layer as between the shaft 211 and outer layer 213. A layer of toner 230 may be present between the two components 200 and 210. The toner supply roller 200 may scrub residual toner which remains on the surface of the developing roller and apply toner from a compartment (not shown) to the outer circumferential surface of the developing roll. The developer roller may then be brought into contact with a photoconductive drum and the toner layer on the developer roller may then be transferred to the photoconductive drum (not shown) so that an electrostatic image on the drum is developed.

For example, the components 200 and 210 may be connected to electrodes which apply an electrical potential between the two components 200 and 210. For example, in one non-limiting exemplary embodiment, the toner may be negatively charged. Current may be passed from a positive electrode 207 affixed to the first component 200 at the shaft 201 and travel from the shaft 201 through the conductive adhesive 203 and into the outer layer 205. From the outer layer 205 of the first component 200, the current may pass to the outer layer 213 of the second component 210. Then it may pass into the shaft 211 and through a negative electrode 217. The toner may also be positively charged and the system and potentials may be arranged to accommodate such positively charged toner.

In one exemplary comparative print test utilizing the conductive adhesive herein, as applied to a toner supply roller shaft containing conductive foam, it was demonstrated that the conductive adhesive provided a more uniform current between the developer roller 210 and toner supply roller 200 over the life of the printer cartridge. This had the observed effect of providing toner with more uniform charge and mass over the cartridge life. In comparative testing, a toner supply roller made of a conductive polyurethane foam along with a conventional non-conductive adhesive showed starvation prior to completion of about 5000 pages. Alternatively, a conductive polyurethane foam along with the use of a conductive adhesive made in accordance with the present invention did not show starvation over the entire cartridge life of about 8000 pages. Furthermore the inventive system herein demonstrated improvements in print quality in a relatively high temperature, high humidity environment as well as in a relatively low temperature, low relatively humid environment.

The foregoing description is provided to illustrate and explain the present invention. However, the description hereinabove should not be considered to limit the scope of the invention set forth in the claims appended here to.

What is claimed is:

1. A conductive toner supply roller for use in supplying image forming material in an image forming apparatus comprising:
a conductive substrate;
a conductive adhesive; and
a conductive foam layer including an outer foam surface, wherein said roller has substantially uniform Shore 00 Hardness across said foam surface.

2. The roller of claim 1 wherein said Shore 00 Hardness is between about 20-80.

3. The roller of claim 1 wherein said Shore 00 Hardness varies about +/×5.0 units.

4. The roller of claim 1 wherein said foam has compression force deflection of less than or equal to about 6.0 psi.

5. The roller of claim 1 wherein said conductive adhesive has a thickness of less or equal to about 400 microns.

6. The roller of claim 1 wherein said conductive adhesive layer has a first resistance R₁, said foam layer has a second resistance R₂, wherein R₁<R₂.

7. The roller of claim 1 wherein said foam has a density of ≦10.0 pounds per cubic foot, a compression force deflection of ≦6.0 psi and said conductive adhesive layer has a thickness of ≦400 microns and said Shore 00 Hardness is between about 20-80.

8. The roller of claim 1 wherein said conductive substrate comprises a metallic shaft.

9. The roller of claim 8 wherein said shaft has an outer surface and said conductive adhesive covers the entirety of said shaft outer surface.

10. The roller of claim 1 wherein said conductive adhesive comprises a thermoplastic or thermoset resin, each including a conductive additive.

11. The roller of claim 10 wherein said resin comprises an epoxy resin and said conductive additive comprises carbon black and graphite and said resin and additive is combined in a solvent and applied to said roller.

12. The roller of claim 1 wherein said roller is located in a printer cartridge.

13. The roller of claim 1 wherein said roller is located in an image forming apparatus.

14. An electrically conductive component for use in an image forming apparatus comprising:
a conductive polymer foam having an outer surface wherein the foam exhibits a density of a density of ≦10.0 pounds per cubic foot, a compression force deflection of ≦6.0 psi and a conductive layer having a thickness of ≦400 microns and wherein said foam outer surface has a Shore 00 Hardness between about 20-80.

15. The component of claim 14 wherein said Shore 00 Hardness is substantially uniform across said foam outer surface.

16. The component of claim 15 wherein said Shore 00 Hardness varies +/−5.0 units.

17. The component of claim 14 wherein said component comprises a roller having a shaft including an outer surface and said conductive layer comprises an adhesive that is applied to the entirety of the shaft outer surface that is in contact with said foam.

18. An image forming device comprising a component as recited in claim 14.

19. A printer cartridge comprising a component as recited in claim 14.

20. A method for applying toner to a developing member in an electrophotographic image-forming apparatus comprising applying toner to said developing member via a roll comprising a conductive foam wherein having an outer surface wherein the foam exhibits a density of a density of ≦10.0 pounds per cubic foot, a compression force deflection of ≦6.0 psi and a conductive layer having a thickness of ≦400 microns and wherein said foam outer surface has a Shore 00 Hardness between about 20-80.

21. The method of claim 20 wherein said Shore 00 Hardness is substantially uniform across said foam outer surface.

22. The method of claim 21 wherein said Shore 00 Hardness varies +/−5.0 units.

23. The method of claim 20 wherein said roller has a shaft having an outer surface and said conductive layer comprises an adhesive that is applied to the entirety of said outer surface contacting said foam.
